(19) United States
(12) Patent Application Publication
(10) Pub. No.: US 2006/0238132 A1
(43) Pub. Date: Oct. 26, 2006

(54) Plasma processing apparatus and method

(75) Inventors: Masayuki Kitamura, Tsukui-gun (JP); Masaki Hirayama, Sendai-shi (JP); Tadahiro Ohmi, Sendai-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: TOKYO ELECTRON LIMITED, Minato-ku (JP); Tohoku University, Sendai-shi (JP)

(21) Appl. No.: 11/391,325

(22) Filed: Mar. 29, 2006

(30) Foreign Application Priority Data
Mar. 30, 2005 (JP) JP2005-099836
Mar. 13, 2006 (JP) JP2006-067835

(51) Int. Cl. H01J 7/24

(52) U.S. Cl. 315/111.21

(57) ABSTRACT

A plasma processing apparatus that passes a microwave, which is introduced into a waveguide, through a slot and propagates the microwave to a dielectric, converts a predetermined gas supplied into a processing chamber into plasma, and applies plasma processing to a substrate, in which a plurality of the waveguides are disposed side by side, a plurality of dielectrics are provided for each of the waveguides, and one slot, or two or more slots is or are provided for each of the dielectrics, is provided. The area of each of the dielectrics can be made extremely small, and a microwave can be reliably propagated into the entire surface of the dielectric. A thin support member that supports the dielectric can be used, a uniform electromagnetic field can be formed in an entire area above the substrate, and uniform plasma can be generated in the processing chamber.

### BACKGROUND OF THE INVENTION

1. Field of the Invention

The present invention relates to a plasma processing apparatus and a method that apply processing such as film-forming to a substrate by generating plasma.

2. Description of the Related Art

For example, in manufacturing processes of an LCD device or the like, an apparatus which generates plasma in a processing chamber by using microwaves and applying CVD processing, etching processing and the like to an LCD substrate is used. As such a plasma processing apparatus, the apparatus in which a plurality of waveguides are arranged in parallel above the processing chamber is known (see Japanese Patent Application Laid-open No. 2004-200646 and Japanese Patent Application Laid-open No. 2004-152876). A plurality of slots are opened side by side in an undersurface of the waveguide, and planar dielectrics are provided along the undersurface of the waveguide. The apparatus is constructed to propagate a microwave into the surfaces of the dielectrics through the slots and convert a predetermined gas (a rare gas for plasma excitation and/or a gas for plasma processing), which is supplied into the processing chamber, into plasma by the energy (electromagnetic field) of the microwave.

However, with upsizing of substrates and the like, the processing apparatuses have become large, and manufacturing of upsized dielectric is especially difficult and increases the manufacturing cost. When the dielectrics become large and heavy, the support member that supports them has to be given a strong structures, but this causes the problem that plasma which generates in the processing chamber tends to be ununiform. Namely, the upsized support member becomes a hindrance and inhibits a uniform electromagnetic field from being formed in an entire area above the substrate, and since the area of the dielectric itself is large, it is sometimes difficult to propagate a microwave uniformly into an entire surface of the dielectrics depending on various conditions such as the kind of the processing gas, the pressure inside the processing chamber and the like.

### SUMMARY OF THE INVENTION

It is an object of the present invention to provide a plasma processing apparatus which is easy to manufacture and capable of generating uniform plasma in a processing chamber and a method.

In order to solve the above described problems, according to the present invention, a plasma processing apparatus, which is a plasma processing apparatus that passes a microwave, which is introduced into a waveguide, through a slot and propagates the microwave to a dielectric, converts a predetermined gas supplied into a processing chamber into plasma, and applies plasma processing to a substrate, characterized in that a plurality of the waveguides are disposed side by side, a plurality of dielectrics are provided for each of the waveguides, and one slot, or two or more slots is or are provided for each of the dielectrics, is provided. In this plasma processing apparatus, a plurality of slots may be provided at each of the aforesaid plurality of waveguides which are disposed side by side, and the dielectric may be provided for each of the slots.

Further, according to the present invention, a plasma processing apparatus, which is a plasma processing apparatus that passes a microwave, which is introduced into a waveguide, through a slot and propagates the microwave to a dielectric, converts a predetermined gas supplied into a processing chamber into plasma, and applies plasma processing to a substrate, characterized in that a plurality of the waveguides are disposed side by side, a plurality of dielectrics are provided for every two or more waveguides, and one slot, or two or more slots is or are provided for each of the dielectrics, is provided. In this plasma processing apparatus, the dielectric may be disposed to stride over the slots which are formed at the two or more waveguides respectively.

In these plasma processing apparatuses, the aforesaid waveguides are, for example, quadrangular waveguides. Further, the aforesaid plurality of dielectrics are each in, for example, a quadrangular flat plate shape. One, or two or more gas ejecting ports that supply a predetermined gas into the processing chamber can be provided at a periphery of each of the plurality of dielectrics, for example. The aforesaid gas ejecting port may be provided in a support member that supports the plurality of dielectrics.

Further, according to the present invention, a plasma processing method, which is a plasma processing method for passing a microwave, which is introduced into a waveguide, through a slot and propagating the microwave to a dielectric, converting a predetermined gas supplied into a processing chamber into plasma, and applying plasma processing to a substrate, characterized in that the microwave is introduced into a plurality of the waveguides which are disposed side by side, and the microwave is propagated to each of a plurality of dielectrics which are provided for each of the waveguides through one slot, or two or more slots, is provided.

Further, according to the present invention, a plasma processing method, which is a plasma processing method for passing a microwave, which is introduced into a waveguide, through a slot and propagating the microwave to a dielectric, converting a predetermined gas supplied into a processing chamber into plasma, and applying plasma processing to a substrate, characterized in that the microwave is introduced into a plurality of the waveguides which are disposed side by side, and the microwave is propagated to each of a plurality of dielectrics which are provided for every two or more waveguides through one slot, or two or more slots, is provided.

### BRIEF DESCRIPTION OF THE DRAWINGS

FIG. 1 is a longitudinal sectional view showing the schematic construction of a plasma processing apparatus according to an embodiment of the present invention;

FIG. 2 is a bottom view showing the disposition of a plurality of dielectrics which are supported on an undersurface of a lid body;

FIG. 3 is a partially enlarged longitudinal sectional view of the lid body;

FIG. 4 is a partially enlarged longitudinal sectional view of the lid body according to the embodiment in which an E-surface that is in a short side direction of a sectional shape of a waveguide is disposed to be horizontal, and an H-surface that is in a long side direction is disposed to be vertical;

FIG. 5 is an explanatory view of gas ejecting ports disposed in the undersurface of a support member;

FIG. 6 is an explanatory view of the support member which is constructed to support corner portions of an undersurface of each of the dielectrics from below;

FIG. 7 is a bottom view of a lid body in which a plurality of rectangular dielectrics are each disposed to stride over two waveguides;

FIG. 8 is an enlarged longitudinal sectional view of the lid body in X-X section in FIG. 7; and

FIG. 9 is an enlarged longitudinal sectional view of the lid body in Y-Y section in FIG. 7.

### DETAILED DESCRIPTION OF THE INVENTION

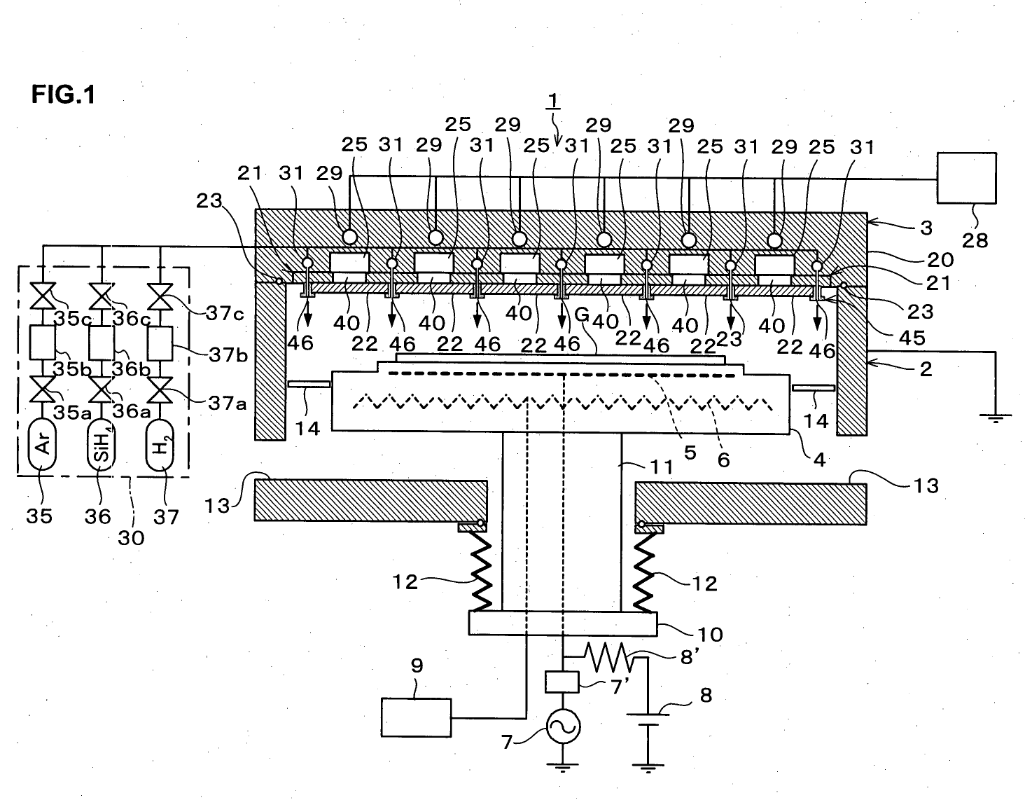

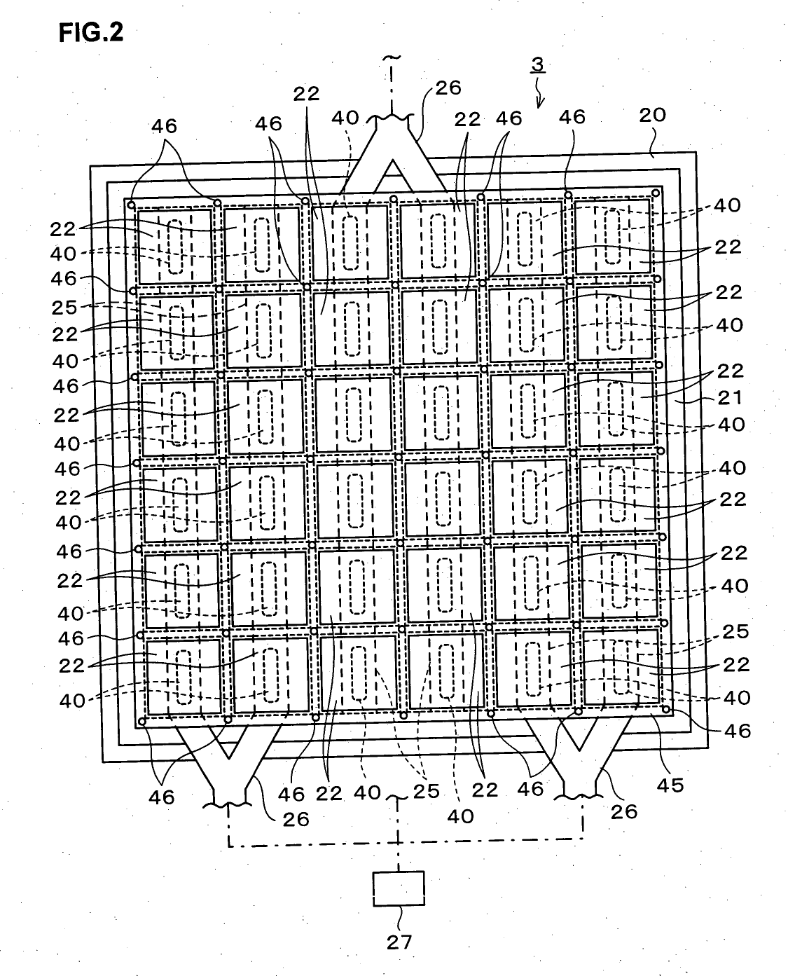

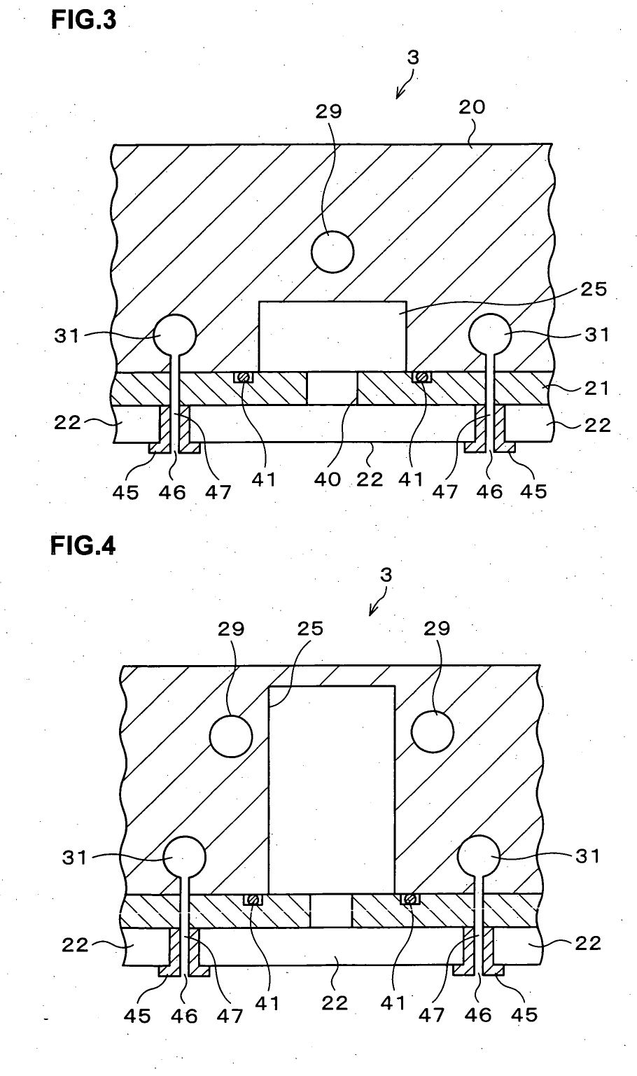

Hereinafter, an embodiment of the present invention will be described based on a plasma processing apparatus 1 that performs CVD (chemical vapor deposition) processing which is one example of plasma processing. FIG. 1 is a longitudinal sectional view showing the schematic construction of the plasma processing apparatus 1 according to the embodiment of the present invention. FIG. 2 is a bottom view showing the disposition of a plurality of dielectrics 22 which are supported on a lid body 3 included by the plasma processing apparatus 1. FIG. 3 is a partially enlarged longitudinal sectional view of the lid body 3.

The plasma processing apparatus 1 includes a processing chamber 2 in a bottomed cubic shape with a top portion opened, and the lid body 3 which closes an upper side of this processing container 2. These processing chamber 2 and the lid body 3 are composed of, for example, aluminum, and both are in the grounded state.

A susceptor 4 as a mounting table for mounting a glass substrate (hereinafter, called “substrate”) G as a substrate is provided inside the processing chamber 2. This susceptor 4 is composed of, for example, aluminum nitride, and is provided therein with a power supplying part 5 which electrostatically sucks the substrate G and applies a predetermined bias voltage to the inside of the processing chamber 2, and a heater 6 which heats the substrate G to a predetermined temperature. An RF (Radio Frequency) generator 7 for applying bias provided outside the processing chamber 2 is connected to the power supplying part 5 via a matching device 7′ which includes a capacitor and the like, and a high-voltage DC power source 8 for electrostatic suction is connected to the power supplying part 5 via a coil 8′. An AC power source 9 which is also provided outside the processing chamber 2 is connected to the heater 6.

The susceptor 4 is supported on a raising and lowering plate 10, which is provided outside and below the processing chamber 2, via a barrel unit 11, and rises and lowers integrally with the raising and lowering plate 10, whereby the height of the susceptor 4 inside the processing chamber 2 is adjusted. A bellows 12 is fitted between a bottom surface of the processing chamber 2 and the raising and lowering plate 10, and therefore, air tightness of the inside of the processing chamber 2 is kept.

An exhaust port 13 for exhausting the atmosphere in the processing chamber 2 by an exhaust device (not shown) such as a vacuum pump provided outside the processing chamber 2 is provided in a bottom portion of the processing chamber 2. A current plate 14 for controlling the flow of a gas inside the processing chamber 2 to a preferable state is provided around the susceptor 4 in the processing chamber 2.

The lid body 3 has a construction in which a slot antenna 21 is attached to a bottom surface of a lid main body 20 composed of, for example, aluminum, and a plurality of dielectrics 22 are attached to a bottom surface of the slot antenna 21. The lid main body 20 and the slot antenna 21 are integrally constructed. In a state in which the upper side of the processing chamber 2 is closed by the lid body 3 as shown in FIG. 1, the air tightness inside the processing chamber 2 is kept by an O-ring 23 which is disposed between a peripheral portion of the bottom surface of the lid main body 20 and a top surface of the processing chamber 2, and an O-ring 41 which is disposed around each slot 40 that will be described later.

A plurality of waveguides 25 are formed on the bottom surface of the lid main body 20. In this embodiment, six waveguides 25 each extending in line are included, and the respective waveguides 25 are disposed in a row to be parallel with each other. Each of the waveguides 25 is constructed to be a so-called quadrangular waveguide which is quadrangular in the sectional shape, and, for example, in the case of a TE10 mode, the waveguides 25 is disposed so that an H-surface is in a long side direction of the sectional shape (quadrangular shape) of each of the waveguides 25 and horizontal, and an E-surface is in a short side direction and vertical. It depends on the mode how the long side direction and the short side direction are disposed. An inside of each of the waveguides 25 is filled with, for example, Al₂O₃, quarts, a fluorine resin or the like.

As shown in FIG. 2, a branch waveguide 26 is connected to an end portion of each of the waveguides 25, and a microwave of, for example, 2.45 GHz which is generated in a microwave feeder 27 provided outside the processing chamber 2 is introduced into each of the waveguides 25 via the branch waveguide 26. Besides, a water conduit 29 which is provided outside the processing chamber 2 and to which cooling water is circulated and supplied from a cooling water supply source 28 which is provided outside the processing chamber 2, and a gas passage 31 to which a predetermined gas is supplied from a gas supply source 30 which is also provided outside the processing chamber 2 are provided inside the lid main body 20. In this embodiment, an argon gas supply source 35, a silane gas supply source 36 as a film-forming gas and a hydrogen gas supply source 37 are prepared as a gas supply source 30, and are connected to a gas passage 31 via respective valves 35a, 36a and 37a, mass flow controllers 35b, 36b and 37b, and valves 35c, 36c and 37c.

The slot antenna 21 which is integrally formed on the bottom surface of the lid main body 20 is composed of a material having electric conductivity, for example, Al. A plurality of slots 40 as through holes are equidistantly disposed at the slot antenna 21. Each space between the slots 40 is set at, for example, λg/2 (λg is a wavelength in the waveguide). In this embodiment, each of the slots 40 is formed into a long hole in a slit shape in plane view, and each of the slots 40 is disposed side by side in line so that the longitudinal direction of each of the slots 40 and the longitudinal direction of the waveguide 25 coincide with each other. A plurality of slots 40 are formed for each of the waveguides 25, and in the embodiment shown in the drawing, six of the slots 40 are provided for each of the six waveguides 25, and the slots 40 at 36 spots in total (6×6=36) are uniformly distributed and disposed on the entire bottom surface of the lid main body 20.

As shown in FIG. 3, an O-ring 41 disposed to surround each of the slots 40 is provided between the bottom surface of the lid main body 20 and the top surface of the slot antenna 21. A microwave is introduced into the waveguide 25 in the atmospheric state, for example, and as the O-ring 41 is disposed to surround each of the slots 40 like this, the air tightness inside the processing chamber can be kept.

As shown in FIG. 2, in this embodiment, the construction in which a plurality of dielectrics 22 each formed into a quadrangular flat plate shape are attached to the bottom surface of the slot antenna 21 is adopted. Each of the dielectrics 22 is composed of, for example, silica glass, AlN, Al₂O₃, sapphire, SiN, ceramics or the like. Each of the dielectrics 22 is attached to each of the slots 40 formed in the slot antenna 21 one by one. Therefore, in the embodiment shown in the drawing, 36 of dielectrics 22 in total (6×6=36) are uniformly distributed and disposed on the entire bottom surface of the lid main body 20.

Each of the dielectrics 22 keeps the state attached to the bottom surface of the slot antenna 21 by being supported by a support member 45 which is formed into a grid shape. The support member 45 is composed of, for example, aluminum, and is in the grounded state with the slot antenna 21. By supporting the peripheral portion of the bottom surface of each of the dielectrics 22 by this support member 45 from below, most part o f the bottom surface of each of the dielectrics 22 is in the state exposed to the inside of the processing chamber 2.

A gas ejecting port 46 for supplying the predetermined gas into the processing chamber 2 in the periphery of each of the dielectrics 22 is provided in each of intersection portions of the support member 45 which is formed into the grid shape like this, and the gas ejecting ports 46 are uniformly distributed and disposed on the entire bottom surface of the lid main body 20. Gas piping 47 which penetrates through the slot antenna 21 and the support member 45 is provided between the gas passage 31 inside the lid main body 20 described above and each of the gas ejecting ports 46. Thereby, the predetermined gas which is supplied into the gas passage 31 from the gas supply source 30 passes through the gas piping 47 and is ejected into the processing chamber 2 from the gas ejecting port 46.

The case where, for example, amorphous silicon film forming is performed in the plasma processing apparatus 1 according to the embodiment of the present invention constructed as above will be described. On processing, the substrate G is placed on the susceptor 4 in the processing chamber 2, and while the predetermined gas, for example, the mixture gas of, for example, an argon gas/a silane gas/hydrogen is supplied into the processing chamber 2 from the gas supply source 30 through the gas passages 31 and the gas piping 47 and the gas ejecting ports 46, the gas is exhausted from the exhaust port 13 to set the inside of the processing chamber 2 at a predetermined pressure. In this case, by ejecting the predetermined gas from the gas ejecting ports 46 which are distributed and disposed on the entire bottom surface of the lid main body 20, the predetermined gas can be uniformly supplied to the entire surface of the substrate G which is placed on the susceptor 4.

While the predetermined gas is supplied into the processing chamber 2 in this manner, the substrate G is heated to a predetermined temperature by the heater 6. The microwave of, for example, 2.45 GHz generated by the microwave feeder shown in FIG. 2 is propagated to each of the dielectrics 22 through each of the slots 40 from each of the waveguides 25 via the branch waveguide 26. An electromagnetic field is formed in the processing chamber 2 by the energy of the microwave propagated to each of the dielectrics 22, and the above described processing gas inside the processing chamber 2 is converted into plasma, whereby amorphous silicon film forming is performed for the surface of the substrate G. In this case, uniform film forming with less damage to the substrate G can be performed by high density plasma of 10¹¹ to 10¹³ cm⁻³ at a low electron temperature of, for example, 0.7 eV to 2.0 eV. The suitable amorphous silicon film forming conditions are such that for example, the pressure inside the processing chamber 2 is 5 to 100 Pa, preferably 10 to 60 Pa, the temperature of the substrate G is 200 to 300° C., preferably 250° C. to 300° C., and the output of the power of the microwave feeder is 500 to 5000 W, preferably 1500 to 2500 W.

According to this plasma processing apparatus 1, a plurality of dielectrics 22 are provided for each of the waveguides 25, and therefore, each of the dielectrics 22 can be made compact and light. Therefore, manufacturing of the plasma processing apparatus 1 becomes easy at low cost, and the ability to respond to upsizing of the surface of the substrate can be enhanced. The slot 40 is provided for each of the dielectrics 22, and the area of each of the dielectrics 22 is extremely small. Therefore, the microwave can be reliably propagated to the entire surface of each of the dielectrics 22 as a surface wave. When the microwave is propagated as a surface wave to the surface of the dielectric with the large area, variation sometimes occurs to the propagating state depending on the process conditions or the like, and uniformity cannot be obtained. On the other hand, according to the plasma processing apparatus 1, the area of each of the dielectrics 22 is extremely small, and therefore, the microwave (surface) can be uniformly propagated on the entire surface of each of the dielectrics 22, thus making it possible to perform uniform plasma processing as the entire processing chamber. Therefore, the process window can be widened, and stable plasma processing is made possible. Since the support member 45 which supports the dielectrics 22 can be made thin, most part of the bottom surface of each of the dielectrics 22 is exposed to the inside of the processing chamber 2, the support member 45 hardly becomes a hindrance when an electromagnetic field is formed in the processing chamber 2, a uniform electromagnetic field can be formed in the entire area above the substrate G, and uniform plasma can be generated in the processing chamber.

By providing the gas ejecting port 46 which supplies the predetermined gas in the support member 45 that supports the dielectric 22 as in the plasma processing apparatus 1 of this embodiment, it becomes unnecessary to dispose a shower head or the like for supplying a processing gas in the processing chamber, and therefore, the apparatus can be simplified. By omitting the shower head or the like, the distance between the dielectric 22 and the substrate G can be shortened, and downsizing of the apparatus, and reduction in amount of the predetermined gas can be achieved. Further, an additional member does not exist between the dielectric 22 and the substrate G, and therefore, occurrence of plasma can be made more uniform. As described in this embodiment, by constructing the support member 45 of metal such as aluminum, for example, work of the gas ejecting port 46, the gas piping 47 and the like is facilitated.

One example of the preferred embodiment of the present invention is described above, but the present invention is not limited to the embodiment shown here. In the embodiment shown in the drawings, six dielectrics 22 are provided for each of the six waveguides 25, but the number of waveguides 25 may be an optional number that is more than one, and the number of dielectrics 22 which are provided for each of the waveguides 25 may be an optional number that is more than one. The numbers of dielectrics 22 provided for the respective waveguides 25 may be the same as each other or different from each other. The example in which the one slot 40 is provided for each of the dielectrics 25 one by one is shown, but a plurality of slots 40 may be provided for each of the dielectrics 22, or the numbers of slots 40 provided for the respective dielectrics 22 may be differ from each other.

As shown in FIG. 4, each of the waveguides 25 may be disposed so that the E-surface is in the short side direction of the sectional shape (quadrangular shape) and horizontal and the H-surface is in the long side direction and is vertical. In this case, the slot 40 which is formed in the slot antenna 21 is disposed on the E-surface which is in the short side direction of the waveguide 25. The embodiment shown in FIG. 4 has the same construction as the embodiment which is described above with FIG. 3 or the like except for the point that the waveguide 25 is disposed so that the E-surface which is in the short side direction of the sectional shape (quadrangular shape) of the waveguide 25 is horizontal, and the H-surface which is in the long side direction is vertical. Therefore, the redundant explanation will be omitted by assigning the identical components in FIG. 4 with the common reference numerals. According to the embodiment shown in FIG. 4, the space between the respective waveguides 25 can be made large, and therefore, for example, the water passage 29 of the cooling water can be disposed at the side of each of the waveguides 25. The number of the waveguides 25 can be easily increased.

The shape of the slot 40 which is formed in the slot antenna 21 can be various shapes without limited to the slit shape. Except that a plurality of slots 40 are disposed in line, a so-called radial line slot antenna in which a plurality of the slots 40 are disposed in a spiral shape or a concentric circle shape can be constructed. The shape of the dielectric 22 may not be a regular square, and may be, for example, a rectangle, a triangle, an optional polygon, a disk, an ellipse and the like. The respective dielectrics 22 may be in the same shape as each other or may be in the different shapes.

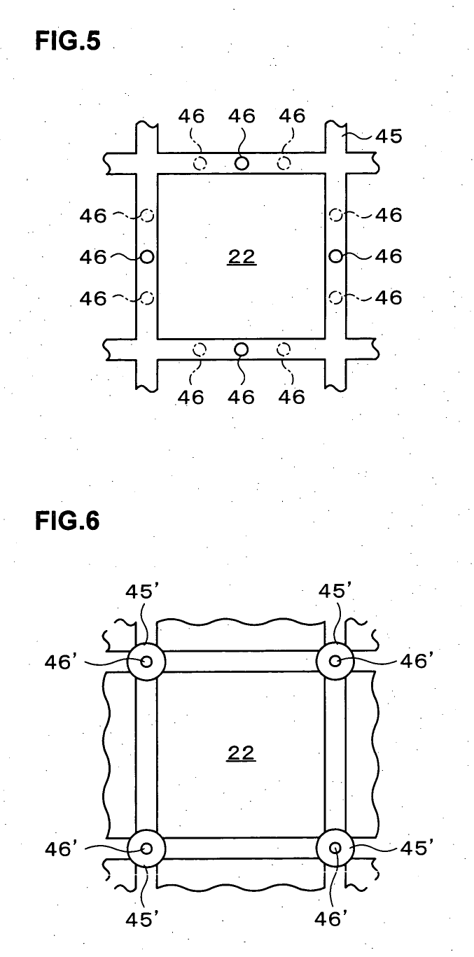

The gas ejecting port 46 which is formed in the support member 45 may not necessarily be disposed at each of the intersection portions of the support member 45, and as shown in FIG. 5, the gas ejecting port 46 may be disposed in the undersurface of the support member 45 between the respective intersection portions so as to supply the predetermined gas to the periphery of each of the dielectrics 22. In this case, as shown by the dashed line in FIG. 5, a plurality of gas ejecting ports 46 may be disposed in the undersurface of the support member 45 between the respective intersection portions. The gas ejecting ports 46 may be disposed between both the respective intersection portions and the respective intersection portions.

The support member 45 that supports each of the dielectrics 22 is not limited to the one formed into the grid shape. As shown in, for example, FIG. 6, support members 45′ that support the undersurface corner portions of each of the dielectrics 22 from below may be used. In this case, by also providing an ejecting port 46′ of a processing gas in the support member 45′, the predetermined gas can be supplied to the periphery of each of the dielectrics 22. In the case where the peripheral portion of the undersurface of the dielectric 22 is supported from below by using the support member 45 which is formed in the grid shape as described in FIG. 2 and the like, there is the advantage of being capable of keeping air tightness inside the processing chamber 2 with higher accuracy, by disposing the O-ring or the like between the peripheral portion of the undersurface of the dielectric 22 and the grid-shaped support member 45.

In the above embodiment, the apparatus which performs amorphous silicon film forming which is one example of plasma processing is described, but the present invention is also applicable to oxide film forming, polysilicon film forming, silane ammonia processing, silane hydrogen processing, oxide film processing, silane oxygen processing, the other CVD processing, and etching processing, in addition to amorphous silicon film forming.

The embodiment in which a plurality of dielectrics 22 are provided for each of the waveguides 25 is described above, but a plurality of dielectrics 22 may be provided for every two waveguides or more.

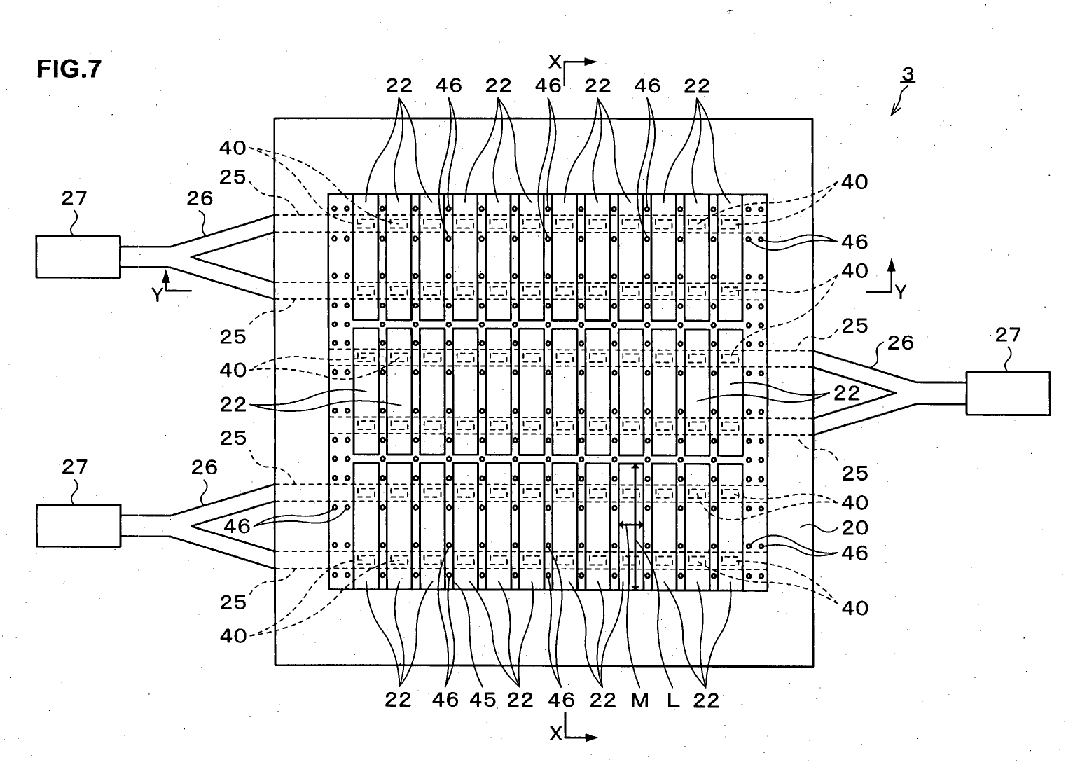

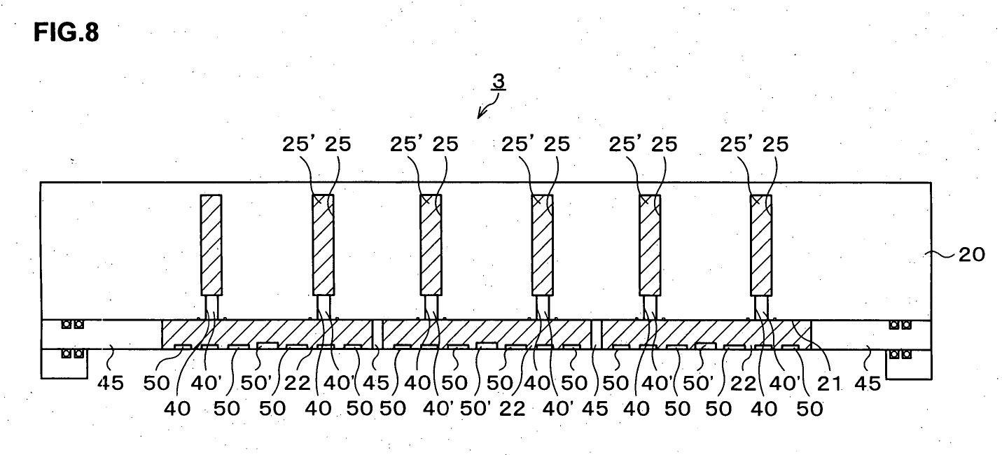

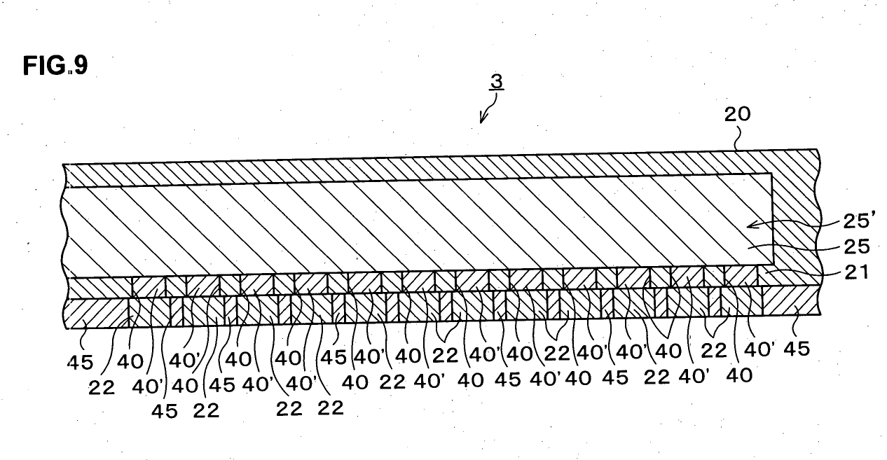

FIG. 7 is a bottom view of the lid body 3 according to an embodiment in which a plurality of dielectrics 22 are provided for every two waveguides 25. FIG. 8 is an enlarged longitudinal sectional view of the lid body 3 in the X-X section in FIG. 7. FIG. 9 is an enlarged longitudinal sectional view of the lid body 3 in the Y-Y section in FIG. 7. As an example, the embodiment in which a plurality of dielectrics 22 are provided for every two waveguides 25, but it goes without saying that a plurality of dielectrics 22 may be provided for every three waveguides 25 or more.

In the embodiment shown in FIGS. 7 to 9, as in the embodiment described above with FIGS. 1 and 2, the lid body 3 has the construction in which the slot antenna 21 is integrally formed on the undersurface of the lid main body 20, and a plurality of dielectrics 22 in the tile form are attached to the undersurface of the slot antenna 21. In the embodiment described above with FIGS. 1 and 2, the dielectric 22 is in the regular square shape, while in this embodiment, the dielectric 22 is formed into a rectangular shape. The lid main body 20 and the slot antenna 21 are integrally constructed of a conductive material such as, for example, aluminum, and are in the electrically grounded state.

Each of the quadrangular waveguides 25 formed inside the lid main body 20 is disposed so that the H-surface is in the long side direction of the sectional shape (quadrangular shape) of each of the quadrangular waveguides 25 and vertical, and the E-surface is in the short side direction and horizontal. It depends on the mode how the long side direction and the short side direction are disposed. In this embodiment, the inside of each of the waveguides 25 is charged with a dielectric member 25′ of, for example, a fluorine resin (for example, Teflon (registered trade name)). As for the material of the dielectric member 25′, dielectric materials such as Al₂O₃ and quarts, for example can be used other than a fluorine resin.

A plurality of slots 40 as through-holes are equidistantly disposed along the longitudinal direction of each of the quadrangular waveguides 25 on the undersurface of each of the quadrangular waveguides 25 which construct the slot antenna 21. In this embodiment (corresponding to G5), twelve slots 40 are provided for each of the quadrangular waveguides 25 by being arranged in series, and in the entire slot antenna 21, the slots 40 at 72 spots (12 slots×6 rows=72 spots) are uniformly distributed and disposed on the entire undersurface (slot antenna 21) of the lid main body 20. The space between the respective slots 40 is set so that the space between the slots 40 adjacent to each other in the longitudinal direction of each of the quadrangular waveguides 25 is, for example, λg′/2 (λg′ is the wavelength in the waveguide of the microwave at 2.45 GHz) at the respective center axes. The number of slots 40 which are formed at each of the waveguides 25 is optional. For example, 13 slots 40 may be provided for each of the quadrangular waveguides 25, and in the entire slot antenna 21, the slots 40 at 78 spots (13×6 rows=78 spots) may be uniformly distributed on the entire undersurface (slot antenna 21) of the lid main body 20.

A dielectric member 40′ composed of, for example, Al₂O₃ is charged into the inside of each of the slots 40 which are uniformly distributed and disposed on the entire slot antenna 21 like this. As the dielectric member 40′, a dielectric material such as a fluorine resin, and quartz, for example, can be used. A plurality of dielectrics 22 which are attached to the undersurface of the slot antenna 21 as described above are respetively disposed under the respective slots 40. Each of the dielectrics 22 is composed of a dielectric material such as, for example, silica glass, AlN, AL₂O₃, sapphire, SiN, and ceramics.

In this embodiment, each of the dielectrics 22 is disposed to stride over the two quadrangular waveguides 25 which are connected to one microwave feeder 27 via the Y branch waveguide 26. As described above, the six quadrangular waveguides 25 in all are disposed in parallel inside the lid main body 20, and the respective dielectrics 22 are disposed in three rows so that each corresponds to two quadrangular waveguides 25.

As described above, 12 slots 40 are disposed on the undersurface (slot antenna 21) of each of the quadrangular waveguides 25 to be arranged in series, and each of the dielectrics 22 is attached so as to stride the respective slots 40 of the two quadrangular waveguides 25 adjacent to each other (the two quadrangular waveguides 25 which are connected to the same micro feeder 27 via the Y branch waveguide 26). Thereby, 36 dielectrics 22 in all (12 dielectrics×3 rows=36 dielectrics) are attached to the undersurface of the slot antenna 21. A beam 45 which is formed into a grid shape for supporting these 36 dielectrics 22 in the state in which they are arranged in 12 dielectrics×3 rows is provided on the undersurface of the slot antenna 21. The number of slots 40 which are formed on the undersurface of each of the quadrangular waveguides 25 is optional, and for example, 13 slots 40 may be provided on the undersurface of each of the quadrangular waveguides 25, and 39 of the dielectrics 22 in all (13 dielectrics×3 rows=39 dielectrics) may be arranged on the undersurface of the slot antenna 21.

The beam 45 is disposed to surround the periphery of each of the dielectrics 22, and supports each of the dielectrics 22 in close contact with the undersurface of the slot antenna 21. The beam 45 is composed of a nonmagnetic conductive material such as aluminum, for example, and is in the electrically grounded state with the slot antenna 21 and the lid main body 20. By supporting the periphery of each of the dielectrics 22 by this beam 45, most part of the undersurface of each of the dielectrics 22 is exposed to the inside of the processing chamber 2.

A space between each of the dielectrics 22 and each of the slots 40 is sealed by using a seal member such as an O-ring. A microwave is introduced in, for example, an atmospheric state to each of the quadrangular waveguides 25 which are formed inside the lid main body 20, but the space between each of the dielectrics 22 and each of the slots 40 is sealed like this, and therefore, the air tightness in the processing chamber 2 is kept.

Each of the dielectrics 22 is formed into a rectangle in which a length L in the longitudinal direction is longer than the free space wavelength λ=about 120 nm of the microwave in the evacuated processing chamber 2, and a length M in the width direction is shorter than the free space wavelength λ. Note that the length L in the longitudinal direction of the dielectric 22 and the length M in the width direction are written in FIG. 7. When the microwave of, for example, 2.45 GHz is generated in the microwave feeder 27, the wavelength λ of the microwave which propagates on the surface of the dielectric is substantially equal to the free space wavelength λ. Therefore, the length L in the longitudinal direction of each of the dielectrics 22 is set to be longer than 120 mm, for example, set at 188 mm. The length M in the width direction of each of the dielectrics 22 is set to be shorter than 120 mm, for example, set at 40 mm.

As shown in FIG. 8, recesses and projections are formed on the undersurface of each of the dielectrics 22. Namely, in this embodiment, on the undersurface of each of the dielectrics 22, which is formed into a rectangle, seven recessed portions 50 and 50′ are disposed along its longitudinal direction to be arranged in series. These recessed portions 50 and 50′ are all formed into substantially rectangles substantially equal to each other in thE-surface view (in the state in which the lid body 3 is seen from below). Inner side surfaces of each of the recessed portions 50 and 50′ are formed into substantially vertical wall surfaces.

The depths of the respective recessed portions 50 and 50′ do not have to be the same depth, the depths of some of them or all of them may differ. In the embodiment shown in FIG. 8, the depth of the recessed portion 50′ which is located just in the middle of the two slots 40 is the largest, and the depth of each of the other recessed portions 50 is smaller than the depth of the recessed portion 50′. Thereby, the thickness of the dielectric 22 at the position of the recessed portion 50 is set at the thickness that practically does not hinder propagation of a microwave. On the other hand, the thickness of the dielectric 22 at the position of the recessed portion 50′ is set at the thickness that practically does not allow propagation of a microwave by causing so-called cutoff. Thereby, propagation of the microwave at the position of the recessed portion 50 which is disposed at the side of the slot 40 of one quadrangular waveguide 25 and propagation of the microwave at the position of the recessed portion 50 which is disposed at the side of the slot 40 of the other quadrangular waveguide 25 are cut off at the position of the recessed portion 50′, and do not interfere with each other, and thus, the interference of the microwave coming out of the slot 40 of the one quadrangular waveguide 25 and the microwave coming out of the slot 40 of the other quadrangular waveguide 25 is prevented.

As the embodiment described above with FIGS. 1 and 2, the gas ejecting ports 46 for supplying a predetermined gas into the processing chamber 2 at the periphery of the respective dielectrics 22 are respectively provided in the undersurface of the beam 45 which supports the respective dielectrics 22. The gas ejecting ports 46 are formed at a plurality of spots for each of the dielectrics 22 to surround the periphery thereof, and thereby, the gas ejecting ports 46 are uniformly distributed and disposed on the entire top surface of the processing chamber 2.

Except for the points that a plurality of rectangular dielectrics 22 are disposed to stride the two waveguides 25, and that the recessions and projections are formed on the undersurface of each of the dielectrics 22, the embodiment shown in FIGS. 7 to 9 has substantially the same construction as the embodiment described above with FIGS. 1 and 2. Therefore, the redundant explanation of same construction will be omitted.

By the plasma processing apparatus 1 according to the embodiment shown in FIGS. 7 to 9, a plurality of dielectrics 22 in the tile form are attached to the top surface of the processing chamber 2, and thereby, each of the dielectrics 22 can be made compact and light in weight. Therefore, the plasma processing apparatus 1 can be easily manufactured at low cost, and the ability to respond to increase in the surface of the substrate G can be enhanced. The slot 40 is provided for each of the dielectrics 22, the area of each of the dielectrics 22 is extremely small, and the recessed portions 50 and 50′ are formed on its undersurface. Therefore, a microwave can be uniformly propagated inside each of the dielectrics 22, and plasma can be efficiently generated on the entire undersurface of the respective dielectrics 22. Therefore, uniform plasma processing can be performed in the entire processing chamber 2. Since the beam 45 (support member) which supports the dielectric 22 can be made slim, most part of the undersurface of each of the dielectrics 22 is exposed to the inside of the processing chamber 2, and the beam 45 hardly becomes a hindrance on forming an electromagnetic field in the processing chamber 2. Thus, a uniform electromagnetic field can be formed in the entire area above the substrate G, so that uniform plasma can be generated in the processing chamber 2.

By ejecting a predetermined gas from the gas ejecting ports 46 which are distributed and disposed on the entire undersurface of the lid body 20, the predetermined gas can be evenly supplied to the entire surface of the substrate G.

On propagating the microwave introduced into the quadrangular waveguide 25 to each of the dielectrics 22 from each of the slots 40, if the size of the slot 40 is insufficient, the microwave does not enter the slot 40 from the quadrangular waveguide 25. However, in the embodiment shown in FIGS. 7 to 9, the dielectric member 40′ with higher dielectric constant than air, such as, for example, a fluorine resin, Al₂O₃, and quartz is charged into each of the slot 40. Therefore, even though the slot 40 does not have a sufficient size, it performs the same functions as the slot 40 which visually has a sufficient size for the microwave to enter. Thereby, the microwave which is introduced from the quadrangular waveguide 25 can be reliably propagated to each of the dielectrics 22 from each of the slots 40.

Since the recessed portions 50 and 50′ are formed on the undersurface of each of the dielectrics 22, the electric field which is substantially orthogonal to the inner side surfaces (wall surfaces) of these recessed portions 50 and 50′ by the energy of the microwave which propagates through the dielectric 22, and plasma can be efficiently generated in the vicinity of them. Further, the generation spots of the plasma can be made stable. Further, the lateral with of the dielectric 22 is set at, for example, 40 mm to be smaller than the microwave free space wavelength λ=about 120 mm, and the length in the longitudinal direction of the dielectric 22 is set at, for example, 188 mm to be longer than the microwave free space wavelength λ, whereby the surface wave can be propagated only in the longitudinal direction of the dielectric 22. Interference of the microwaves which are propagated from the two slots 40 can be prevented by the recessed portion 50′ which is provided in the center of each of the dielectrics 22.

The example in which the dielectric member 25′ such as a fluorine resin, Al₂O₃, and quartz is disposed inside each of the quadric waveguides 25 is described, but the inside of each of the quadrangular waveguides 25 may be hollow. When the dielectric member 25′ is disposed inside the quadrangular waveguide 25, the wavelength λg in the waveguide can be made shorter as compared with the case where the inside of the quadrangular waveguide 25 is made hollow. Thereby, the space between the respective slots 40 which are disposed side by side along the longitudinal direction of the quadrangular waveguide 25 can be made short, and the number of slots 40 can be increased correspondingly. Thereby, the dielectric 22 can be made further small, and the number of placed dielectrics 22 can be further increased. Thus, the effects of downsizing and reduction in weight of the dielectric 22, and uniform plasma processing in the entire processing chamber 2 can be further increased.

The example in which the seven recessed portions 50 and 50′ are provided on the undersurface of the dielectric 22 is described, but the number and the shape of recessed portions provided on the undersurface of the dielectric 22 and arrangement are optional. The shapes of the respective recessed portions may be different. By providing projected portions on the undersurface of the dielectric 22, the recesses and projections may be formed on the undersurface of the dielectric 22. At any rate, by providing the recesses and projections on the undersurface of the dielectric 22, and forming substantially vertical wall surfaces on the undersurface of the dielectric 22, a substantially vertical electric field is formed by the energy of the microwave propagated to the vertical wall surfaces, plasma can be efficiently generated in the vicinity thereof, and the generation spots of plasma can be stabilized.

The present invention is applicable to, for example, CVD processing and etching processing.

According to the present invention, by providing a plurality of dielectrics for a plural of waveguides, or by providing a plurality of dielectrics for every two waveguides or more, each of the dielectrics can be made compact and light, and the ability to respond to increase in the surface of a substrate can be enhanced. Therefore, manufacturing of the plasma processing apparatus is made easy at low cost. One or two or more of slots are provided for each dielectric, and the area of each dielectric can be made extremely small. Therefore, a microwave can be reliably propagated in the entire surface of the dielectric. Since the slim support member for supporting the dielectrics can be used, a uniform electric field can be formed in the entire area above the substrate, and uniform plasma can be generated in the processing chamber.

If the gas ejecting ports for supplying the processing gas are provided in the support member which supports the dielectrics, a shower head or the like for supplying the processing gas does not have to be disposed between the dielectrics and the substrate in the processing chamber; and therefore, the apparatus can be simplified. By omitting the shower head or the like, the distance between the dielectrics and the substrate can be made short, film forming processing and etching rate can be enhanced, the apparatus can be downsized, and the amount of the processing gas can be reduced.

What is claimed is:

1. A plasma processing apparatus that passes a microwave, which is introduced into a waveguide, through a slot and propagates the microwave to a dielectric, converts a predetermined gas supplied into a processing chamber into plasma, and applies plasma processing to a substrate,
wherein a plurality of the waveguides are disposed side by side, a plurality of dielectrics are provided for each of the waveguides, and one slot, or two or more slots is or are provided for each of the dielectrics.

2. The plasma processing apparatus according to claim 1,
wherein a plurality of slots are provided at each of the plurality of waveguides which are disposed side by side, and the dielectric is provided for each of the slots.

3. The plasma processing apparatus according to claim 1,
wherein the waveguide is a quadrangular waveguide.

4. The plasma processing apparatus according to claim 1,
wherein the plurality of dielectrics are each in a quadrangular flat plate shape.

5. The plasma processing apparatus according to claim 1,
wherein one, or two or more gas ejecting ports that supply a predetermined gas into the processing chamber is or are provided at a periphery of each of the plurality of dielectrics.

6. The plasma processing apparatus according to claim 5,
wherein the gas ejecting port is provided in a support member that supports the plurality of dielectrics.

7. A plasma processing apparatus that passes a microwave, which is introduced into a waveguide, through a slot and propagates the microwave to a dielectric, converts a predetermined gas supplied into a processing chamber into plasma, and applies plasma processing to a substrate,
wherein a plurality of the waveguides are disposed side by side, a plurality of dielectrics are provided for every two or more waveguides, and one slot, or two or more slots is or are provided for each of the dielectrics.

8. The plasma processing apparatus according to claim 7,
wherein the dielectric is disposed to stride over the slots which are formed at the two or more waveguides respectively.

9. The plasma processing apparatus according to claim 7,
wherein the waveguide is a quadrangular waveguide.

10. The plasma processing apparatus according to claim 7,
wherein the plurality of dielectrics are each in a quadrangular flat plate shape.

11. The plasma processing apparatus according to claim 7,
wherein one, or two or more gas ejecting ports that supply a predetermined gas into the processing chamber is or are provided at a periphery of each of the plurality of dielectrics.

12. The plasma processing apparatus according to claim 11,
wherein the gas ejecting port is provided in a support member that supports the plurality of dielectrics.

13. A plasma processing method for passing a microwave, which is introduced into a waveguide, through a slot and propagating the microwave to a dielectric, converting a predetermined gas supplied into a processing chamber into plasma, and applying plasma processing to a substrate,
wherein the microwave is introduced into a plurality of the waveguides which are disposed side by side, and the microwave is propagated to each of a plurality of dielectrics which are provided for each of the waveguides through one slot, or two or more slots.

14. A plasma processing method for passing a microwave, which is introduced into a waveguide, through a slot and propagating the microwave to a dielectric, converting a predetermined gas supplied into a processing chamber into plasma, and applying plasma processing to a substrate,
wherein the microwave is introduced into a plurality of the waveguides which are disposed side by side, and the microwave is propagated to each of a plurality of dielectrics which are provided for every two or more waveguides through one slot, or two or more slots.
